(19) United States
(12) Patent Application Publication
(10) Pub. No.: US 2022/0226763 A1
(43) Pub. Date: Jul. 21, 2022

(54) EXHAUST EMISSION CONTROL FILTER

(71) Applicant: HONDA MOTOR CO., LTD., Tokyo (JP)

(72) Inventors: Chiaki SEKI, Tokyo (JP); Masanori HASHIMOTO, Tokyo (JP); Naohiro SATO, Tokyo (JP); Tomoko TSUYAMA, Tokyo (JP); Michiya YANO, Tokyo (JP); Yoshiaki HATAKEYAMA, Tokyo (JP)

(21) Appl. No.: 17/577,394

(22) Filed: Jan. 18, 2022

(30) Foreign Application Priority Data
Jan. 19, 2021 (JP) 2021-006575
Jan. 12, 2022 (JP) 2022-003375

(51) Int. Cl. B01D 46/24; F01N 3/035

(52) U.S. Cl. CPC B01D 46/24492; B01D 46/24491; B01D 2279/30; B01D 2275/10; F01N 3/035

(57) ABSTRACT

An exhaust emission control filter is provided that can reduce the pressure loss and has a high exhaust conversion performance and particulate matter capturing performance. An exhaust emission control filter includes: a filter base material having a wall flow structure; and an exhaust conversion catalyst carried on partitions of the filter base material. The median gas pore diameter (D50) of the filter base material after the exhaust conversion catalyst is carried on the filter base material is 17 μm or more. The half width of the gas pore distribution of the filter base material ranges from 7 to 15 μm. The exhaust conversion catalyst is ununiformly carried in a high-density layer having a relatively high density of the exhaust conversion catalyst and a low-density layer having a relatively low density of the exhaust conversion catalyst. The maximum gas pore diameter of the high-density layer is 11.7 μm or less.

This application is based on and claims the benefit of priority from Japanese Patent Application Nos. 2021-006575 and 2022-003375, respectively filed on 19 Jan. 2021 and 12 Jan. 2022, the content of which is incorporated herein by reference.

### BACKGROUND OF THE INVENTION

### Field of the Invention

The present invention relates to an exhaust emission control filter including an exhaust conversion catalyst.

### Related Art

Conventionally, among gasoline engines mounted on automobiles, adoption of gasoline direct injection engines has been advanced in view of combustion efficiency improvement and the like. Unfortunately, the gasoline direct injection engines emit more particulates, such as PM, than port injection (PI) engines. Accordingly, accompanied by tightening of emission regulations in recent years (PM emission regulation, PN (the number of exhaust particulates) regulation), discussion on a technique of providing an exhaust path of a gasoline engine with an exhaust emission control filter (a gasoline particulate filter; hereinafter called “GPF”) for capturing particulates has been advanced.

The exhaust path of a gasoline engine is provided with a three-way catalyst (hereinafter called “TWC”), which removes CO, HC and NOx contained in exhaust, in a state of being held by a honeycomb holder. In particular, in recent years, multiple TWCs are arranged in series on the exhaust path in order to satisfy the performance required for catalytic conversion. Accordingly, it is not preferable to newly provide a GPF on the exhaust path in addition to these TWCs, in view of pressure loss and cost.

Accordingly, a technique that causes the GPF to hold the TWCs and provides not only the particulate matter capturing performance but also a three-way conversion function has been proposed (for example, see Patent Document 1).
Patent Document 1: Japanese Unexamined Patent
Application, Publication No. 2017-082745

### SUMMARY OF THE INVENTION

However, achievement of a desired particulate matter capturing performance requires use of a filter base material that is included in the GPF and has a small gas pore diameter.

In this case, there is a problem in that the pressure loss increases and causes reduction in output. This problem is further significant because the longer the traveling distance is, the more particulates, such as ash derived from oil, are captured by the exhaust emission control filter.

There is a method of improving the particulate matter capturing performance by coating the catalyst. However, conventionally, holding of the catalyst on a filter base material having a typical gas pore diameter has a restriction on the amount of catalyst held by GPF in view of pressure loss described above. Accordingly, the exhaust conversion performance has not been expected in comparison with the conventional TWCs. That is, the pressure loss, the exhaust conversion performance and the particulate matter capturing performance have a tradeoff relationship.

The present invention has been made in view of the above description, and has an object to provide an exhaust emission control filter that can reduce the pressure loss and has a high exhaust conversion performance and particulate matter capturing performance.

(1) To achieve the object described above, the present invention provides an exhaust emission control filter (e.g., a GPF 32 described later) provided on an exhaust path (e.g., exhaust pipe 3 described later) of an internal combustion engine (e.g., an engine 1 described later) and capturing and removing particulates in exhaust of the internal combustion engine. The exhaust emission control filter includes: a filter base material (e.g., a filter base material 320 described later) which includes a plurality of cells extending from an inlet end face of exhaust to an outlet end face and is partitioned by porous partitions (e.g., partitions 323 described later) and in which inlet cells with an opening at the inlet end face being sealed, and outlet cells with an opening at the outlet end face being sealed are arranged alternately; and an exhaust conversion catalyst (e.g., TWC 33 described later) carried on the partitions. The filter base material has a median gas pore diameter (D50) of 17 μm or more after the exhaust conversion catalyst is carried on the filter base material, a half width of a gas pore distribution of the filter base material ranges from 7 to 15 μm, the exhaust conversion catalyst is ununiformly carried in a high-density layer (e.g., a high-density layer 331 described later) having a relatively high density of the exhaust conversion catalyst and a low-density layer (e.g., a low-density layer 332 described later) having a relatively low density of the exhaust conversion catalyst, and the high-density layer has a maximum gas pore diameter of 11.7 μm or less.

According to the aspect (1), in the exhaust emission control filter that includes what is called a wall flow type filter base material, and the exhaust conversion catalyst carried on the material, the median gas pore diameter (D50) of the filter base material after the exhaust conversion catalyst is carried is 17 μm or more, which is relatively large. The exhaust conversion catalyst is carried on the filter base material ununiformly in the layer with a relatively high density and in the layer with a relatively low density.

According to the aspect (1), some of partitions in the thickness direction where relatively large gas pore diameters are secured after the exhaust conversion catalyst is carried include the high-density layer where exhaust conversion catalyst is arranged in a layered manner at high density. Accordingly, the exhaust flow path is sufficiently secured, and the uniformity of the exhaust flow is secured. As a result, increase in pressure loss can be suppressed in an acceptable range. Here, the present applicant has found out that there is a correlation between the initial increase in pressure loss due to particulates and the increase in pressure loss after particulate matter deposition. That is, if the increase in pressure loss due to particulates can be suppressed, the increase in pressure loss after particulate matter deposition can be reduced. In view of this point, the effect of suppressing increase in pressure loss by the aspect (1) described above is exerted from the initial stage. Accordingly, the aspect (1) can reduce the increase in pressure loss after particulate matter deposition.

According to the aspect (1), the high-density layer where exhaust conversion catalyst is arranged in a layered manner at high density at some part of partitions 323 in the thickness direction is included, and the maximum gas pore diameter of the high-density layer is 11.7 μm or less, which is relatively small. Consequently, exhaust surely passes through the flow paths narrowed by the exhaust conversion catalyst arranged at the high density. Accordingly, a high particulate matter capturing performance and a high exhaust conversion performance can be achieved. According to the aspect (1), the increase in pressure loss due to particulates can be suppressed, and the pressure loss after particulate matter deposition can be reduced. In turn, the pressure loss can be reduced without limiting the amount of carrying the exhaust conversion catalyst. Accordingly, the pressure loss can be reduced, and the exhaust emission control filter that has a high exhaust conversion performance and particulate matter capturing performance can be provided.

Furthermore, according to the aspect (1), the half width of the peak of the gas pore distribution of the filter base material ranges from 7 to 15 μm. That is, in the exhaust emission control filter according to the aspect (1), the gas pore diameter is large, and the half width of the gas pore distribution is narrow. Accordingly, when the exhaust conversion catalyst is carried on the filter base material, blockage of the gas pores by the slurry that contains the exhaust conversion catalyst flowing preferentially into gas pores having small gas pore diameters owing to the capillary action can be prevented. Accordingly, reduction of the exhaust flow paths in the partitions can be suppressed, and the exhaust emission control filter that can further suppress the increase in pressure loss even after the exhaust conversion catalyst is carried can be provided. Since the number of flow paths is large, the probability of contact between the exhaust containing particulates and the exhaust conversion catalyst is increased. Accordingly, the exhaust emission control filter that has a higher exhaust conversion performance and particulate matter capturing performance can be provided.

(2) In the exhaust emission control filter according to (1), wherein the median gas pore diameter (D50) after the exhaust conversion catalyst is carried on the filter base material may be 20 μm or more.

In the aspect (2), the median gas pore diameter (DSO) of the filter base material after the exhaust conversion catalyst is carried is 20 μm or more. Accordingly, the increase in pressure loss can be further suppressed, and the effect of the aspect (1) can be more improved.

(3) In the exhaust emission control filter according to (1) or (2), the maximum gas pore diameter of the high-density layer may be 7.7 μm or less.

According to the aspect (3), the maximum gas pore diameter of the high-density layer may be 7.7 μm or less. Accordingly, a higher particulate matter capturing performance and a higher exhaust conversion performance can be achieved, which can further improve the effect of the invention (1).

(4) In the exhaust emission control filter according to any of (1) to (3), the half width of the gas pore distribution of the filter base material may range from 7 to 9 μm.

Furthermore, according to the aspect (4), the half width of the peak of the gas pore distribution of the filter base material before the exhaust conversion catalyst is carried ranges from 7 to 9 μm. Accordingly, the reduction in the exhaust flow paths in the partitions can be suppressed even after the exhaust conversion catalyst is carried, thereby further improving the advantageous effect of the aspect (1).

(5) In the exhaust emission control filter according to any of (1) to (4), the gas pore rate of the filter base material may range from 55% to 70%.

According to the aspect (5), the gas pore rate of the filter base material before the exhaust conversion catalyst is carried ranges from 55% to 70%. Accordingly, the exhaust flow paths can be more sufficiently secured, thereby further improving the advantageous effect of the aspect (1).

According to the present invention, an exhaust emission control filter can be provided that can reduce the pressure loss and has a high exhaust conversion performance and particulate matter capturing performance.

### BRIEF DESCRIPTION OF THE DRAWINGS

FIG. 1 shows the configuration of an exhaust emission control device of an internal combustion engine according to one embodiment of the present invention;

FIG. 2 is a sectional view of a GPF according to the embodiment;

FIG. 3 is a sectional view of partitions of the GPF according to the embodiment;

FIG. 4 is a schematic sectional view showing an example of the structure of the partition of the GPF according to the embodiment;

FIG. 5 is a schematic sectional view showing another example of the structure of the partition of the GPF according to the embodiment;

FIG. 6 is a schematic sectional view showing still another example of the structure of the partition of the GPF according to the embodiment;

FIG. 7 shows measurement points of a perm porometer and a mercury porosimeter.

FIG. 8 shows the relationship between the median gas pore diameter and the initial pressure loss;

FIG. 9 shows the relationship between the maximum gas pore diameter of a high-density layer and the PN reduction rate;

FIG. 10 shows the relationship between the maximum gas pore diameter of a high-density layer and the CPI;

FIG. 11 shows the relationship between the PN collecting efficiency and the pressure loss after ash deposition in each of Examples and Comparative Examples; and

FIG. 12 shows the relationship between the CPI and the pressure loss after ash deposition in each of Examples and Comparative Examples.

### DETAILED DESCRIPTION OF THE INVENTION

Hereinafter, embodiments of the present invention are described with reference to the drawings.

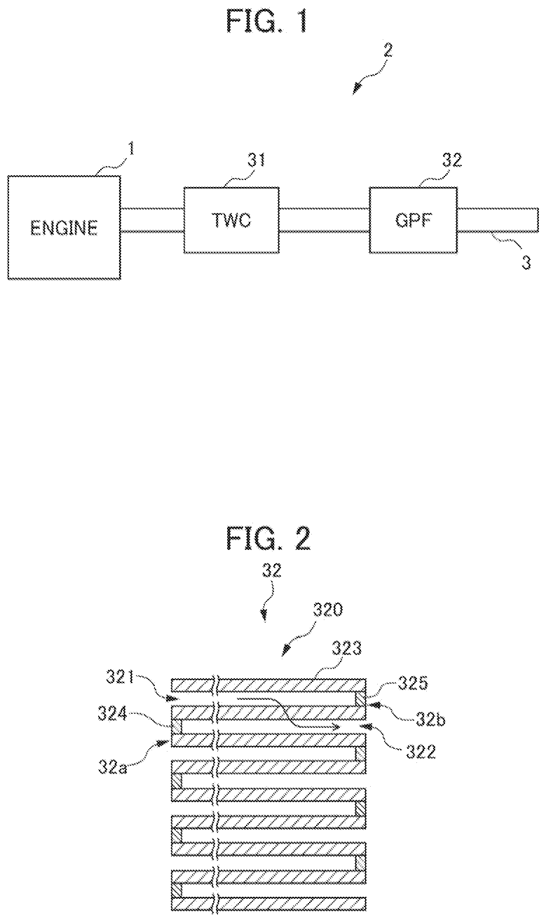

FIG. 1 shows the configuration of an exhaust emission control device 2 of an internal combustion engine (hereinafter called “engine”) 1 according to this embodiment. The engine 1 is a direct injection type gasoline engine. As shown in FIG. 1, the exhaust emission control device 2 includes a TWC 31 and a GPF 32 as an exhaust emission control filter, which are provided in an order from the upstream of the exhaust pipe 3 through which exhaust flows.

The TWC 31 oxidizes or reduces HC to HO and CO₂, CO to CO₂, and NOₓ to N₂ in exhaust, thereby achieving emission control. The TWC 31 may be what includes, for example, a carrier made of an oxide, such as of alumina, silica, zirconia, titania, ceria or zeolite, and a noble metal, such as Pd or Rh, carried as a catalytic metal by the carrier. Typically, the TWC 31 is carried on a honeycomb holder.

The TWC 31 includes an OSC material having an OSC capability. The OSC material may be not only CeO₂ but also a complex oxide of CeO₂ and ZrO₂ (hereinafter “CeZr complex oxide”) and the like is used. Among them, the CeZr complex oxide is preferably used because it has a high durability. Note that the catalytic metal may be carried on the OSC material.

The method of preparing the TWC 31 is not specifically limited. The conventionally publicly known slurry process or the like may be used for preparation. For example, after the slurry including the oxide, noble metal and OSC material described above is prepared, a honeycomb holder made of cordierite is coated with the prepared slurry, and is calcined, thereby achieving the preparation.

The GPF 32 captures and removes particulates in exhaust. Specifically, when exhaust passes through fine pores in partitions described later, the particulates are deposited on the surfaces of the partitions, thereby capturing the particulates.

Here, the particulates in this specification encompasses soot (carbon soot), soluble organic fractions (SOF), ash that is oil cinders, and particulates, such as PM. In recent years, emission regulations for these particulates have been tightened. Not only the regulation (PM regulation) for the gross emission weight of particulates (g/km, g/kW), but also, for example, the number of exhaust particulates having particle diameters 2.5 μm or less, such as PM 2.5 (PN regulation) are becoming effective. Meanwhile, the GPF 32 according to this embodiment can conform to these PM regulations and PN regulations.

FIG. 2 is a sectional view of the GPF 32 according to this embodiment. As shown in FIG. 2, the GPF 32 includes a filter base material 320, and an exhaust conversion catalyst (TWC 33 in this embodiment) carried on the partitions 323 of the filter base material 320. The filter base material 320 has, for example, a cylindrical shape elongated in the axial direction is made of a porous body, such as of cordierite, mullite, or silicon carbide (SiC). The filter base material 320 is provided with a plurality of cells extending from an inlet end face 32a to an outlet end face 32b. These cells are partitioned by the partitions 323.

The filter base material 320 includes inlet seals 324 that seal openings at the inlet end face 32a. The cells with the openings at the inlet end face 32a being sealed by the inlet seals 324 are blocked at the inlet end while being opened at the outlet end, thus constituting outlet cells 322 that allow exhaust having passed through the partitions 323 to flow downstream. The inlet seals 324 are formed by injecting sealing cement from the inlet end face 32a of the filter base material 320 to achieve enclosure.

The filter base material 320 includes outlet seals 325 that seal openings at the outlet end face 32b. The cells with the openings at the outlet end face 32b being sealed by the outlet seals 325 are blocked at the outlet end while being opened at the inlet end, thus constituting inlet cells 321 that allow exhaust flow thereinto from an exhaust pipe 3. The outlet seals 325 are formed by injecting sealing cement from the outlet end face 32b of the filter base material 320 to achieve enclosure.

Note that the openings of the cells at the inlet end face 32a and the openings at the outlet end face 32b are alternately sealed, thereby alternately arranging the inlet cells 321 with the openings at the outlet end face 32b being sealed and the outlet cells 322 with the openings at the inlet end face 32a being sealed. More specifically, the inlet cells 321 and the outlet cells 322 are arranged adjacent to each other to form a lattice shape (in a checkered manner).

As indicated by an arrow in FIG. 2, exhaust flowing into the inlet cells 321. flows from air flow layers into the partitions 323, subsequently passes in the partitions 323 and flows to the outlet cells 322. A side where the exhaust flows into the partitions 323 is the inlet side. A side where the exhaust flows from the partitions 323 is an outlet side.

The gas pore distribution of the filter base material 320 according to this embodiment is measured by a mercury porosimeter. The gas pore distribution is represented with the abscissa axis being the gas pore diameter (μm) and with the ordinate axis being Log differential gas pore volume distribution dV/d(log D) (ml/g). In this embodiment, the median gas pore diameter (D50) according to the volume standard of the filter base material 320 after the exhaust conversion catalyst is carried is 17 μm or more. The more preferable median gas pore diameter (D50) according to the volume standard of the filter base material 320 after the exhaust conversion catalyst is carried is 20 μm or more.

That is, the filter base material 320 of this embodiment has a median gas pore diameter of 17 μm or more, which is relatively large, even after the exhaust conversion catalyst is carried. Accordingly, the exhaust flow paths for flows into the partitions 323 can be sufficiently secured. In particular, as described later, according to this embodiment, the position of carrying the TWC 33 as the exhaust conversion catalyst is devised, which suppresses reduction (blockage) in the gas pore diameters of gas pores in the filter base material 320 due to the TWC 33. Consequently, the exhaust flow paths are sufficiently secured. As a result, the pressure loss can be reduced.

Here, the half width of the gas pore distribution is an indicator that indicates the degree of sharpness of the peak of the gas pore distribution. In this embodiment, the half width of the gas pore distribution of the filter base material 320 before the exhaust conversion catalyst is carried ranges from 7 to 15 μm, which are narrow. The more preferable half width ranges from 7 to 9 μm.

That is, in the filter base material 320 in this embodiment, the gas pore diameter is large and the half width of the gas pore distribution is narrow before the exhaust conversion catalyst is carried. The half width thus ranges from 7 to 15 μm. Accordingly, when the TWC 33 is carried on the filter base material 320, blockage of the gas pores by the slurry that contains the TWC 33 flowing preferentially into gas pores having small gas pore diameters owing to the capillary action can be prevented. Accordingly, reduction of the exhaust flow paths in the partitions 323 can be suppressed, and the GPF 32 that can further suppress the increase in pressure loss even after the exhaust conversion catalyst is carried can be provided. Since the number of flow paths is large, the probability of contact between the exhaust containing particulates and the TWC 33 is increased. Accordingly, a higher exhaust conversion performance and particulate matter capturing performance can be achieved.

Preferably, the gas pore rate of the filter base material 320 before the exhaust conversion catalyst is carried ranges from 55% to 70%. When the gas pore rate of the filter base material 320 before the exhaust conversion catalyst is carried ranges from 55% to 70%, the abrupt pressure loss when the TWC 33 is carried can be suppressed.

Preferably, the average gas pore diameter of the filter base material before the exhaust conversion catalyst is carried ranges from 20 to 30 μm. When the average gas pore diameter of the filter base material before the exhaust conversion catalyst is carried ranges from 20 to 30 μm, the median gas pore diameter of the filter base material 320 can be configured as 17 μm or more even after the exhaust conversion catalyst is carried.

Preferably, the thicknesses of the partitions 323 range from 5 to 15 mil. When the thicknesses of the partitions 323 range from 5 to 15 mil, the pressure loss can be reduced, and a high exhaust conversion performance and particulate matter capturing performance can be achieved.

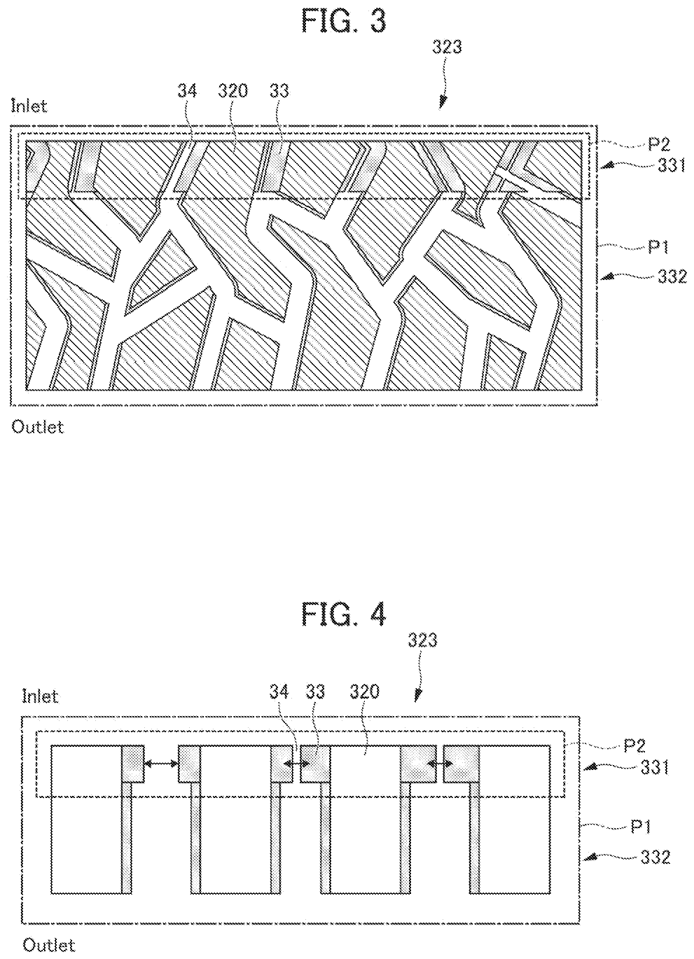

FIG. 3 is a sectional view of the partition 323 of the GPF 32 according to the embodiment. In FIG. 3, hatched parts represent the filter base material 320, white parts represent gas pores, and black parts represent TWC (three-way catalyst) 33 as the exhaust conversion catalyst. The upper side in FIG. 3 indicates the inlet of the partition 323, and the lower side indicates the outlet of the partition 323. That is, the inlet of the partition 323 constitutes an inner wall surface of the inlet cell 321, and the outlet of the partition 323 constitutes an inner wall surface of the outlet cell 322.

At part of the partition 323 in the thickness direction, i.e., the inlet side of the partition 323 in the example shown in FIG. 3, a high-density layer 331 on which the TWC 33 is carried at a high density is arranged. As described above, in the GPF 32 in this embodiment, the TWC 33 is carried biasedly in the high-density layer 331 having a relatively high density and in the low-density layer 332 having a relatively low density.

As described above, the GPF 32 of this embodiment includes the high-density layer 331 where the TWC 33 is arranged in a layered manner at high density, at some of partitions 323 in the thickness direction where relatively large gas pore diameters of 20 μm or more. Accordingly, the exhaust flow paths are sufficiently secured, and the uniformity of the exhaust flow is secured. As a result, increase in pressure loss can be suppressed in an acceptable range. Here, the present applicant has found out that there is a correlation between the initial increase in pressure loss due to particulates and the increase in pressure loss after particulate matter deposition. That is, if the initial increase in pressure loss due to particulates can be suppressed, the increase in pressure loss after particulate matter deposition can be reduced. In view of this point, the effect of suppressing increase in pressure loss described above is exerted from the initial stage. Accordingly, this embodiment can reduce the increase in pressure loss after particulate matter deposition.

As shown in FIG. 3, in the GPF 32 in this embodiment, the gas pore diameters of the gas pores 34 in the high-density layer 331 are narrowed by the TWC 33 carried on the inner wall surfaces of the gas pores in comparison with those in the low-density layer 332. Specifically, in this embodiment, the maximum gas pore diameter of the high-density layer 331 is 11.7 μm or less. More preferably, the maximum gas pore diameter of the high-density layer 331 is 7.7 μm or less.

The high-density layer 331 where the TWC 33 is arranged at part of the partition 323 in the thickness direction in a layered manner at high density is configured, and the maximum gas pore diameter of the high-density layer 331 is 11.7 μm or less, which is relatively small. Consequently, the relatively large gas pore diameters of 20 μm or more are secured as a whole, while partially, exhaust securely passes through the flow paths narrowed by the TWC 33 arranged at high density in the high-density layer 331. Accordingly, a high particulate matter capturing performance and a high exhaust conversion performance can be achieved.

Consequently, according to this embodiment, the increase in pressure loss due to particulates can be suppressed, and the pressure loss after particulate matter deposition can be reduced. In turn, the pressure loss can be reduced without limiting the amount of carrying the TWC 33. Accordingly, the pressure loss can be reduced, and a high exhaust conversion performance and particulate matter capturing performance can be achieved.

FIG. 4 is a schematic sectional view showing an example of the structure of the partition 323 of the GPF 32 according to the embodiment. More specifically, this diagram schematically shows the structure of the partition 323 of the GPF 32 shown in FIG. 3. As shown in FIGS. 3 and 4, the TWC 33 is carried on the inner wall surfaces of the gas pores 34 over the entire partition 323. In particular, the TWC 33 is carried at high density at the part of the partition 323 closer to the inlet (high-density layer 331). Note that the arrangement of the high-density layer 331 is not limited thereto. The layer may be arranged at any part in the thickness direction of the partition 323.

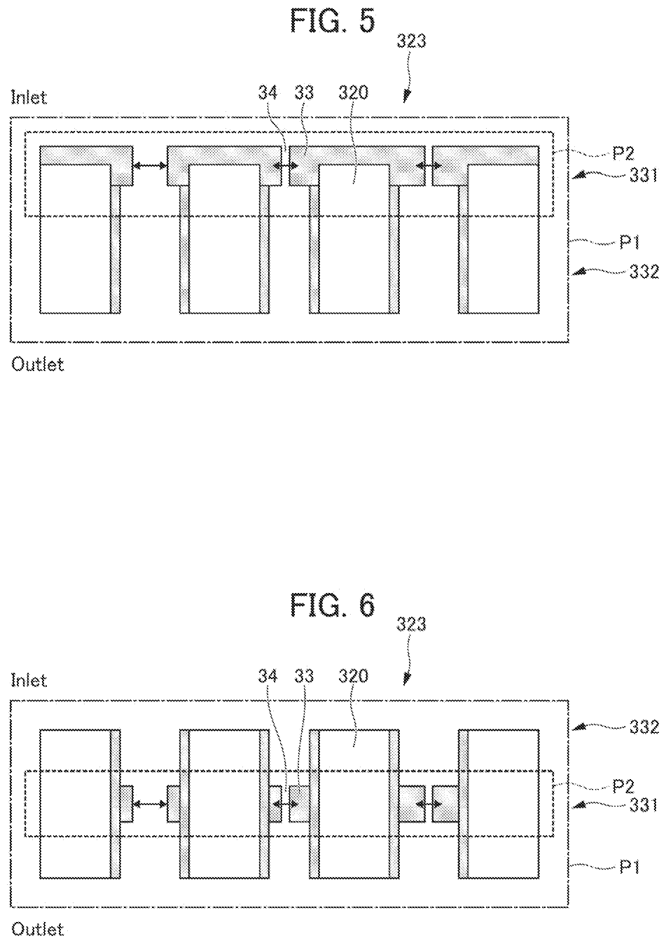

FIG. 5 is a schematic sectional view showing another example of the structure of the partition 323 of the GPF 32 according to this embodiment. In the example shown in FIG. 5, the high-density layer 331 where the TWC 33 is arranged in a layered manner at high density is arranged on the external surface of the partition 323 and adjacent thereto. More specifically, the high-density layer 331 is arranged on the external surface on the inlet side of the partition 323 and adjacent thereto.

FIG. 6 is a schematic sectional view showing another example of the structure of the partition 323 of the GPF 32 according to this embodiment. In the example shown in FIG. 6, the high-density layer 331 where the TWC 33 is arranged in a layered manner at high density is arranged at the substantially center in the thickness direction of the partition 323.

Preferably, in each high-density layer 331 in each example described above, at least 50 percent by mass of TWC 33 in the entire TWC 33 carried on one partition 323 is allocated. Accordingly, each advantageous effect of this embodiment described above is more securely exerted. The pressure loss can be further reduced, and a higher exhaust conversion performance and particulate matter capturing performance can be achieved.

Similar to the TWC 31 described above, the TWC 33 oxidizes or reduces HC to H₂O and CO₂, CO to CO₂, and NOx to N₂, thereby achieving emission control. The TWC 33 may be what includes, for example, a carrier made of an oxide, such as of alumina, silica, zirconia, titania, ceria or zeolite, and a noble metal, such as Pd or Rh, carried as a catalytic metal by the carrier.

The TWC 33 contains an OSC material (oxygen absorption and release capacity material). The OSC material may be not only CeO₂ but also a complex oxide of CeO₂ and ZrO₂ (hereinafter “CeZr complex oxide”) and the like is used. Among them, the CeZr complex oxide is preferably used because it has a high durability. Note that the catalytic metal may be carried on the OSC material. To exert the catalytic action of the TWC described above simultaneously and effectively, it is preferable to keep the ratio of air to fuel (hereinafter called “air-fuel ratio”) around the stoichiometric ratio in a complete combustion reaction (hereinafter called “stoichiometry”). An OSC material having an oxygen storing and releasing capability of storing oxygen under an oxidizing atmosphere and releasing oxygen under a reducing atmosphere is used as a promotor together with the catalytic metal, thereby achieving a higher catalytic conversion performance.

The method of preparing the TWC 33 is not specifically limited. The conventionally publicly known slurry process or the like may be used for preparation. For example, after the slurry containing the oxide, the noble metal and the OSC material described above is prepared through milling, the filter base material 320 is coated with the prepared slurry, and is calcined, thereby achieving the preparation.

Preferably, the amount of wash coat of the TWC 33 having the configuration described above ranges from 30 to 150 g/L. When the amount of wash coat of the TWC 33 is in this range, a high catalytic conversion performance and particulate matter capturing performance can be achieved while reducing the increase in pressure loss. Note that in this embodiment, the TWC 33 may contain another noble metal, e.g., Pt, as a catalytic metal.

The GPF 32 according to this embodiment having the configuration described above is manufactured by a piston pushing up method, for example. The piston pushing up method fabricates the slurry containing a predetermined amounts of component materials of the TWC 33 through milling, and causes the filter base material 320 to carry the TWC 33 at a WC amount of 60 g/L according to the piston pushing up method with the inlet end face of the filter base material 320 serving as a slurry inlet. Subsequently, through drying and calcination, the GPF 32 is achieved.

An example of forming (arranging) the high-density layer 331 on the external surface of the filter base material 320 and adjacent thereto may be a method of impregnating the filter base material 320 with a slurry having a high viscosity, and setting the suction pressure low. There is another method of using a slurry where relatively large particles remain due to reduction in milling time period in slurry preparation. An example of forming (arranging) the high-density layer 331 in parts of the partition 323 on the inlet side and the outlet side may be a method of impregnating the filter base material 320 with a slurry having a high viscosity, and setting the suction pressure high. An example of forming (arranging) the high-density layer 331 in part of the filter base material 320 at the middle in the thickness direction may be a method of impregnating the filter base material 320 with a slurry having a low viscosity, and setting the suction time period short.

According to the GPF 32 in this embodiment manufactured as described above, the median gas pore diameter of the filter base material 320 after the TWC 33 described above is carried is measured by a mercury porosimeter. More specifically, the median gas pore diameter of the filter base material 320 after the TWC 33 is carried is the median gas pore diameter in an entire part P1 indicated by chain lines in FIGS. 3 to 6.

In this embodiment, the maximum gas pore diameter in the high-density layer 331 is measured by the perm porometer. More specifically, the maximum gas pore diameter in the high-density layer 331 is the maximum gas pore diameter in part P2 indicated by broken lines in FIGS. 3 to 6.

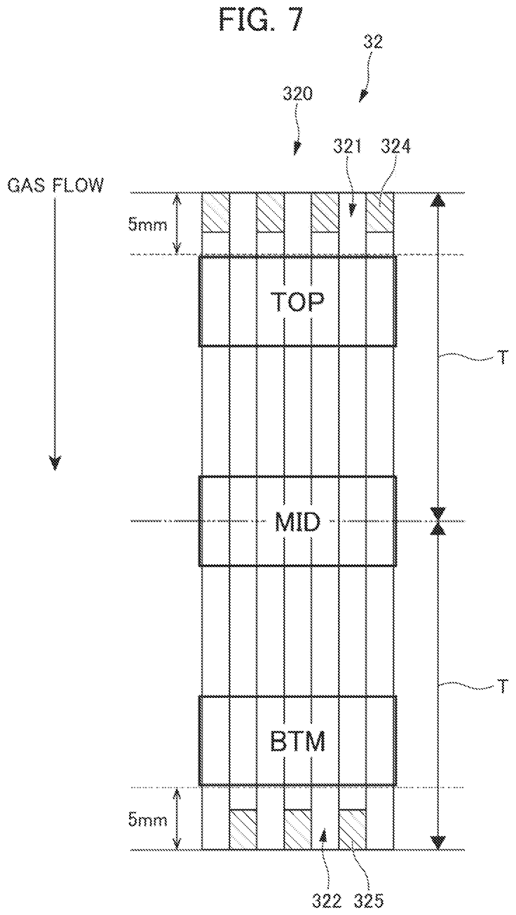

Here, FIG. 7 shows measurement points of a perm porometer and a mercury porosimeter. In FIG. 7, the inlet of the GPF 32 described above is indicated as TOP, the middle part with a distance from the inlet in the inflow gas flow direction being T and with a distance from the outlet being T is indicated as MID, and the outlet is indicated as BTM.

Measurement of the maximum gas pore diameter in the high-density layer 331 using a perm porometer measures three points that are TOP, MID and BTM shown in FIG. 7, and adopts the average value thereof. Note that for example, when it is determined that the cell length is uniform due to EPMA or the like, the measured value at BTM may be adopted as a representative value. The perm porometer measures the through hole distribution of the partitions 323 according to the bubble point method. More specifically, the through hole distribution is measured from the pressure lost when the GPF 32 is immersed with alcohol and the gas pressure increased. A gas pore diameter distribution when the gas pores penetrating through the partition 323 is observed from the surface of the partition 323 at the inlet cells 321 and the surface of the partition at the outlet cells 322 is obtained.

Measurement of the median gas pore diameter of the filter base material 320 using a mercury porosimeter after the TWC 33 is carried measures the three points that are TOP, MID and BTM shown in FIG. 7, and adopts the average value thereof. The GPF 32 is immersed with mercury, and the pressure is changed and mercury infiltrates; based on the pressure at this time, the mercury porosimeter measures the gas pore diameter. More specifically, in the gas pore distribution, all the gas pores (including non-through pores) other than closed pores are considered and the gas pore diameters in the entire region from the surface of the partition at the inlet cells 321 to the surface of the partition at the outlet cells 322 are reflected.

Next, a result of simulation about the initial pressure loss, PN reduction rate, and honeycomb property of the GPF 32 according to this embodiment having the aforementioned configuration is described. Note that the simulation was performed by causing exhaust to flow in a model conforming to an actual case, in a manner similar to the actual case.

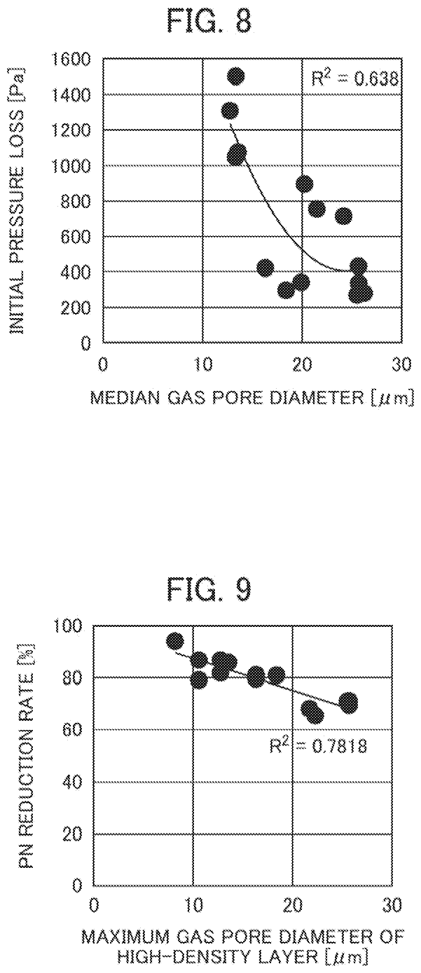

FIG. 8 shows the relationship between the median gas pore diameter and the initial pressure loss. As shown in FIG. 8, it is understood that when the median gas pore diameter of the filter base material 320 after the TWC 33 is carried is 17 μm or more, the initial pressure loss can be sufficiently reduced. As described above, there is a correlation between the initial increase in pressure loss due to particulates and the increase in pressure loss after particulate matter deposition. Accordingly, in this embodiment, the effect of suppressing increase in pressure loss is exerted from the initial stage. Consequently, it can be said that the increase in pressure loss after particulate matter deposition can be reduced.

FIG. 9 shows the relationship between the maximum gas pore diameter of the high-density layer 331 and the PN reduction rate. As shown in FIG. 9, it is understood that when the maximum gas pore diameter of the high-density layer 331 is 11.7 μm or less, a PN reduction rate exceeding 801 can be achieved.

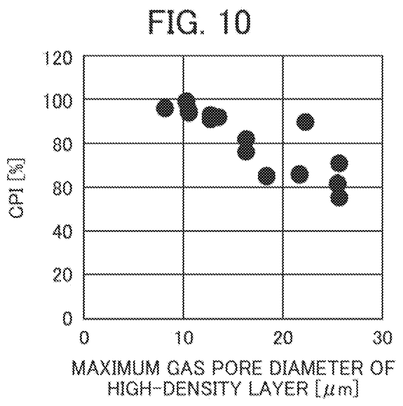

FIG. 10 shows the relationship between the maximum gas pore diameter of the high-density layer 331 and the CPI. Here the CPI (Coat Performance Index) is obtained by dividing the NOx conversion efficiency of GPF by the NOx conversion efficiency of TWC carried on a typical honeycomb carrier (without sealing), and is a NOx conversion indicator for TWC.

As shown in FIG. 10, it is understood that even when the maximum gas pore diameter of the high-density layer 331 is 11.7 μm or less, a sufficient conversion performance is achieved.

The present invention is not limited to the embodiment described above. Modification and improvement in a range capable of achieving the object of the present invention can be encompassed in the present invention. In the embodiment described above, the exhaust emission control filter according to the present invention is applied to GPF. However, there is no limitation thereto. The exhaust emission control filter according to the present invention may be applied to DPF. In this case, the exhaust conversion catalyst is not limited to TWC. Another exhaust conversion catalyst may be used. For example, an oxidation catalyst, such as a PM combustion catalyst may be used.

### EXAMPLES

Next, Examples of the present invention are described. However, the present invention is not limited to these Examples.

### Examples 1 to 4, Comparative Examples 1 to 7

First, nitrite Pd and nitrite Rh solutions and Al₂O₃ carrier (commercially available γ-alumina) were put into an evaporator, and the Al₂O₃ carrier is impregnated with Pd and Rh at a mass ratio of 6/1. Next, after drying, calcination was performed at 600° C., and Pd—Rh/Al₂O₃ catalyst was achieved. Likewise, nitrite Pd, nitrite Rh and CeO₂ were prepared, and Pd—Rh/CeO₂ catalyst was achieved. In each case, the noble metal carrying amounts were 1.51 percent by mass of Pd and 0.25 percent by mass of Rh. Note that the filter base material (carrier) used herein had a size of ϕ118.4×91 mm and 1 L. The average gas pore diameter of the filter base material used herein ranged from 20 to 30 μm. The half width of the gas pore distribution ranged from 7 to 15 μm. The gas pore rate ranged from 55 to 70%. The wall thickness ranged from 5 to 15 mil. The catalyst carrying amount ranged from 30 to 150 g/L.

Next, the same amounts of Pd—Rh/Al₂O₃ catalyst and Pd—Rh/CeO₂ catalyst were mixed with each other, water and binder were additionally mixed, and milling was performed by a ball mill, thus preparing the slurry. In each of Examples and Comparative Examples, the slurry viscosity was adjusted, and the slurry suction pressure in the catalyst carrying step was adjusted, thereby arranging the high-density layer of the exhaust conversion catalyst on the inlet side as shown in FIGS. 3 and 4. Lastly, drying was performed at 150° C. with an air flow, and calcination was performed at 600° C., thereby obtaining each GPF. Table 1 shows the median gas pore diameter (μm) of the filter base material after the exhaust conversion catalyst is carried, and the maximum gas pore diameter (μm) of the high-density layer.

[Actual Vehicle Particulate Matter Collecting Test]

For each of the GPFs according to Examples and Comparative Examples, the GPF to be tested was mounted after 1 L three-way catalytic converter below a gasoline direct injection engine with a displacement of 1.5 L. Under a condition of a room temperature of 25° C. and a humidity of 50%, a WLTP mode drive was performed, the numbers of PMs (PN) before and after GPF in this case were measured, and the number of PMs (PN) collecting efficiency was calculated. For the measurement, as a preprocess, one-cycle WLTP drive was performed, the remaining particulates were removed by the GPF, subsequently, soaking was performed for 24 hours at a room temperature of 25° C., and measurement was performed from a cold state and data was obtained.

[Pressure Loss Test after Ash Endurance]

For each of the GPFs according to Examples and Comparative Examples, a durability test using calcium sulfate as mock ash was performed. Specifically, first calcium sulfate was calcined, and subsequently milling was performed until particle diameters close to those of actual ash were obtained. Next, a self-made aspirator (a large dry pump (design displacement of 1850 L/min.) was connected to a tank for vacuuming) was used, and aspiration of a predetermined amount of mock ash was performed through the filter base material, thereby simulating durability of actual drive. Ash deposition was set to 150 g.

[Pressure Loss]

The pressure loss of GPF according to each of Examples and Comparative Examples was measured using a catalyst carrier pressure loss testing instrument made by Tsukubarikaseiki. Specifically, the GPF full-size (ϕ118.4×91 mm) was set, air was caused to flow at a flow rate of 2.17 m³/min (COLD FLOW), and the pressure loss was measured.

[Conversion Performance (CPT)]

For the exhaust conversion performance according to each of Examples and Comparative Examples, CPT (Coat Performance Index) was calculated. Here the CPI is obtained by dividing the NOx conversion efficiency of GPF by the NOx conversion efficiency of TWC carried on a typical honeycomb carrier (without sealing), and is a NOx conversion indicator of GPF for TWC. Specifically, aging was performed under an aging condition described later, and subsequently, through simulation measurement under a 400° C. stationary SV performance measurement condition, the NOx conversion efficiency of GPF and the NOx conversion efficiency of TWC carried by a typical honeycomb carrier (without sealing) (hereinafter called NOx conversion efficiency of TWC) were measured, and CPI was calculated by the following Expression (1).

(Aging Condition)

Rich/Air Aging(Rich:80 sec./Air:20 sec.)

H₂O=10%

Rich:C₃H₆=1%,O₂=2.5%,N₂=balance gas

Air:O₂=21%,N₂=balance gas

980° C.×10 hours

400° C. stationary SV performance measurement condition T/P size: ϕ1 inch×30 mm (BTM part on the outlet side in a case with sealing)

Gas flow rate:63→51→38→25 L/min.

(SV=250,000/h→200,000/h→150,000/h→100,000/hours)

Gas composition:CO₂=14%,O₂=0.48%.,C₃H₆=400ppm,CO=5000ppm,H₂=1700ppm,NO=500ppm,H_{2O}=10%,N₂=balance gas

[Expression 1]

CPI=NOx conversion efficiency byGPF/NOx conversion efficiency byTWC Expression (1)

TABLE 1

| | | | | | MAXIMUM GAS |
|---|---|---|---|---|---|
| | PRESSURE LOSS | | | | PORE DIAMETER |
| | AFTER ASH | | | MEDIAN GAS | OF HIGH- |
| | DEPOSITION | PN COLLECTING | | PORE DIAMETER | DENSITY LAYER |
| | (kPa) | EFFICIENCY | CPI | (μm) | (μm) |
| Example 1 | 1.8 | 1.0 | 0.9 | 20.4 | 11.7 |
| Example 2 | 2.0 | 1.0 | 1.0 | 23.7 | 9.0 |
| Example 3 | 2.0 | 1.0 | 1.0 | 17.0 | 2.0 |
| Example 4 | 1.8 | 0.9 | 0.9 | 22.5 | 7.7 |
| Comparative | 1.5 | 0.9 | 0.8 | 18.0 | 18.0 |
| Example 1 | | | | | |
| Comparative | 4.4 | 0.9 | 0.9 | 13.6 | 13.6 |
| Example 2 | | | | | |
| Comparative | 9.0 | 0.9 | 1.0 | 11.7 | 11.7 |
| Example 3 | | | | | |
| Comparative | 8.7 | 0.8 | 0.9 | 13.4 | 13.4 |
| Example 4 | | | | | |
| Comparative | 2.0 | 0.7 | 0.2 | 26.7 | 24.0 |
| Example 5 | | | | | |
| Comparative | 1.1 | 0.8 | 0.1 | 28.4 | 28.4 |
| Example 6 | | | | | |
| Comparative | 3.1 | 0.6 | 0.2 | 25.8 | 25.8 |
| Example 7 | | | | | |

Each numerical value in Table 1 is a value rounded to the first decimal place.

### DISCUSSION

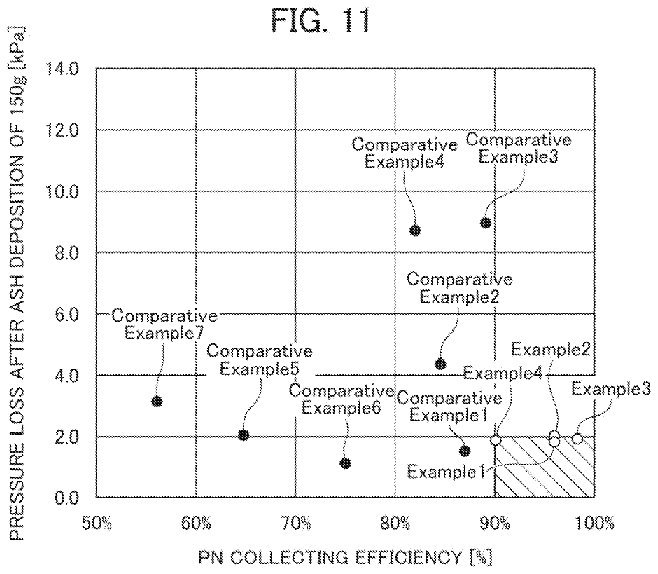

FIG. 11 shows the relationship between the PN collecting efficiency and the pressure loss after ash deposition in each of Examples and Comparative Examples. In FIG. 11, it has been confirmed that when a range of satisfying compatibility between the PN collecting efficiency that is a property required for GPF in an actual vehicle and the pressure loss after deposition of ash of 150 g is adopted so that the PN collecting efficiency of 90% or more and the pressure loss after ash deposition of 150 g is 2.0 kPa or less, only Examples 1 to 4 can achieve the compatibility.

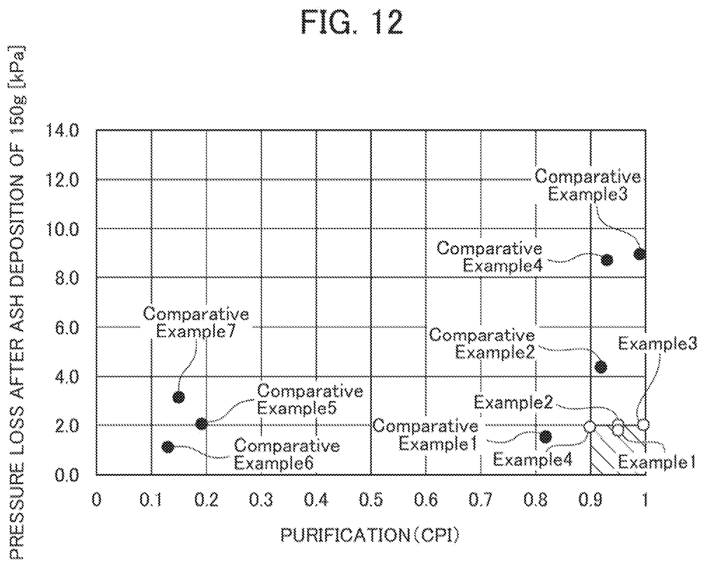

FIG. 12 shows the relationship between the emission control CPI and the pressure loss after ash deposition in each of Examples and Comparative Examples. In FIG. 12, it has been confirmed that when a range of satisfying compatibility between the CPT and the pressure loss after deposition of ash of 150 g is adopted so that the CPI of 0.9 or more and the pressure loss after ash deposition of 150 g is 2.0 kPa or less, only Examples 1 to 4 can achieve the compatibility.

As the result described above, according to the Example where the median gas pore diameter (D50) after the exhaust conversion catalyst is carried on the filter base material was 17 μm or more, the half width of the gas pore distribution of the filter base material ranges from 7 to 15 μm, and the maximum gas pore diameter of the high-density layer is 11.7 μm or less, the pressure loss can be reduced, and a high exhaust conversion performance and particulate matter capturing performance can be achieved. Consequently, the advantageous effects exerted by the present invention have been proved.

### EXPLANATION OF REFERENCE NUMERALS

1 . . . Engine (internal combustion engine)
2 . . . Exhaust emission control device
3 . . . Exhaust pipe (exhaust path)
32 . . . GPF (exhaust emission control filter)
32a . . . Inlet end face
32b . . . Outlet end face
33 . . . TWC (exhaust conversion catalyst)
34 . . . Gas pores
320 . . . Filter base material
323 . . . Partition
321 . . . Inlet cell.
322 . . . Outlet cell
324 . . . Inlet seal
325 . . . Outlet seal
331 . . . High-density layer
332 . . . Low-density layer

What is claimed is:

1. An exhaust emission control filter provided on an exhaust path of an internal combustion engine and capturing and removing particulates in exhaust of the internal combustion engine, the exhaust emission control filter comprising:
a filter base material which includes a plurality of cells extending from an inlet end face of exhaust to an outlet end face and is partitioned by porous partitions and in which inlet cells with an opening at the inlet end face being sealed, and outlet cells with an opening at the outlet end face being sealed are arranged alternately; and
an exhaust conversion catalyst carried on the partitions,
wherein the filter base material has a median gas pore diameter (D50) of 17 μm or more after the exhaust conversion catalyst is carried on the filter base material,
a half width of a gas pore distribution of the filter base material ranges from 7 to 15 μm,
the exhaust conversion catalyst is ununiformly carried in a high-density layer having a relatively high density of the exhaust conversion catalyst and a low-density layer having a relatively low density of the exhaust conversion catalyst, and
the high-density layer has a maximum gas pore diameter of 11.7 μm or less.

2. The exhaust emission control filter according to claim 1, wherein the median gas pore diameter (D50) after the exhaust conversion catalyst is carried on the filter base material is 20 μm or more.

3. The exhaust emission control filter according to claim 1, wherein the maximum gas pore diameter of the high-density layer is 7.7 μm or less.

4. The exhaust emission control filter according to claim 2, wherein the maximum gas pore diameter of the high-density layer is 7.7 μm or less.

5. The exhaust emission control filter according to claim 1, wherein the half width of the gas pore distribution of the filter base material ranges from 7 to 9 μm.

6. The exhaust emission control filter according to claim 2, wherein the half width of the gas pore distribution of the filter base material ranges from 7 to 9 μm.

7. The exhaust emission control filter according to claim 3, wherein the half width of the gas pore distribution of the filter base material ranges from 7 to 9 μm.

8. The exhaust emission control filter according to claim 4, wherein the half width of the gas pore distribution of the filter base material ranges from 7 to 9 μm.

9. The exhaust emission control filter according to claim 1, wherein a gas pore rate of the filter base material ranges from 55% to 70%.

10. The exhaust emission control filter according to claim 2, wherein a gas pore rate of the filter base material ranges from 55% to 70%.

11. The exhaust emission control filter according to claim 3, wherein a gas pore rate of the filter base material ranges from 55% to 70%.

12. The exhaust emission control filter according to claim 4, wherein a gas pore rate of the filter base material ranges from 551, to 70%.

13. The exhaust emission control filter according to claim 5, wherein a gas pore rate of the filter base material ranges from 55% to 70%.

14. The exhaust emission control filter according to claim 6, wherein a gas pore rate of the filter base material ranges from 55% to 70%.

15. The exhaust emission control filter according to claim 7, wherein a gas pore rate of the filter base material ranges from 55% to 70%.

16. The exhaust emission control filter according to claim 8, wherein a gas pore rate of the filter base material ranges from 55% to 70%.
